(19) United States
(12) Patent Application Publication
(10) Pub. No.: US 2007/0112705 A1
(43) Pub. Date: May 17, 2007

(54) Balloon/airborne communication system

(75) Inventor: Aris Mardirossian, Germantown, MD (US)

Correspondence Address: NIXON & VANDERHYE, PC, 901 NORTH GLEBE ROAD, 11TH FLOOR, ARLINGTON, VA, 22203, US

(73) Assignee: Technology Patents, LLC, Derwood, MD (US)

(21) Appl. No.: 11/272,435

(22) Filed: Nov. 14, 2005

(51) Int. Cl. G06F 15/18

(52) U.S. Cl. 706/21; 706/24; 340/825.69; 340/825.25

(57) ABSTRACT

A system and method for enabling an airborne communication system when a natural disaster is detected, or when it is detected that an occurrence of a natural disaster is imminent or likely, is provided. In certain example embodiments, a natural disaster detector monitors, for example, various climatic indicators to determine whether a natural disaster is about to occur, is currently occurring, or has just occurred. An elevation device or system with an attached communication component(s) may elevate before, during, or after the natural disaster, depending on the example embodiment. Once the communication component is airborne, the communication system will create or restore a particular communication channel. In other example embodiments, a plurality of elevation devices, each with their own associated communication components may be elevated to facilitate a node-like implementation.

### FIELD OF THE INVENTION

Certain example embodiments of this invention relate to a system and method for permitting an airborne communication system to be realized when a natural disaster is detected. In certain example embodiments, a system and/or method is provided for enabling an airborne communication system when a natural disaster is detected by elevating at least a central communication server. In certain other example embodiments, a system and/or method is provided for enabling an airborne communication system when a natural disaster is detected by elevating at least nodes in a distributed communication infrastructure.

### BACKGROUND AND SUMMARY OF EXAMPLE EMBODIMENTS OF THE INVENTION

Natural disasters—including tropical depressions, hurricanes, tornados, and wildfires—injure and kill thousands in the United States. Though not common in the U.S., tsunamis and earthquakes pose similar threats elsewhere around the world. The devastating effects of natural disasters are not limited to immediate injuries to people in the direct path of the storms. Rather, damage to critical infrastructure, emergency supplies, and the like hampers the effective response of rescue workers. For example, water supplies may become contaminated as flood waters rage out of control. Hospitals may be leveled, preventing the treatment of otherwise routine injuries. Disease may spread. And blocked roads, collapsed bridges, and the like prevent the effective movement of resources from one place to another. Thus, there is a real and dire risk that many people in disaster areas will suffer new injuries, face further maladies, or even die while rescue workers struggle to help them. Communication is critical in this respect.

Ordinarily, the provision of goods and services is accomplished through a complex communication and information network. In disaster areas, there is a heightened need for the efficient delivery of goods and services, particularly medical supplies and food. But when disaster strikes, damage frequently is done to the critical communication and information infrastructure, challenging both the provision of supplies and the coordination of relief efforts.

Traditional communication methods that include ground components typically cannot withstand the awesome force of nature, or they are simply rendered inoperable. For example, tornadoes can knock over telephone poles, earthquakes can swallow cell towers, and hurricanes can envelop satellite transmitters and/or receivers. Components used in more resilient communication methods may be too expensive, slow and/or difficult to implement, or prove ineffective because of their proprietary nature.

Thus, it will be appreciated that there exists a need in the art for a method and/or system for enabling an airborne communication system when a natural disaster is detected and/or realized, at least to serve as a tool for assisting responders to coordinate relief efforts.

Therefore, certain example embodiments of this invention seek to provide low-cost, highly-flexible alternative communication systems when natural disasters are detected. In accordance with certain example embodiments, a method is provided for establishing an airborne communication system. In certain example embodiments, the method comprises detecting a natural disaster, elevating a communication component, and activating said communication component. The natural disaster may be, for example, a tropical depression, an earthquake, a hurricane, a tornado, a tsunami, a wildfire, and/or a terrorist attack. In some example embodiments, the detecting step may determine the presence of a natural disaster by monitoring barometric pressure, temperature, seismic activity, and/or water levels. Some example embodiments also may include the step of requiring verification before elevating and/or activating the communication component. Depending on the example embodiment, the activating step may enable communication via telephones, cellular telephones, and/or walkie-talkies.

Other example embodiments provide a method for establishing an airborne communication system, comprising the following steps of detecting a natural disaster, elevating a plurality of communication components, and activating the plurality of communication components. In some example embodiments, the elevating step elevates communication components to replace communication components damaged by the natural disaster.

Certain example embodiments provide a system that establishes an airborne communication system. Such a system may comprise a natural disaster detector, an elevating device, and a communication component attached to the elevating device. In some example embodiments, the natural disaster detector determines the presence of a natural disaster by monitoring barometric pressure, temperature, seismic activity, and/or water levels. In other example embodiments, a user confirms the output of the natural disaster detector and/or activates the communication component. In still other example embodiments, the communication component enables communication via telephones, cellular telephones, and/or walkie-talkies. Furthermore, the communication component may enable communication over a secure and/or a restricted channel. In certain example embodiments, the elevation device is a balloon.

In certain other example embodiments, a system of establishing an airborne communication system is provided, which comprises a natural disaster detector, a plurality of elevating devices, and a plurality of communication components attached to the plurality of elevating devices. In other embodiments, communication components are elevated to replace communication components damaged by said natural disaster.

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is a flowchart according to an example embodiment;

FIG. 2A is a partial schematic view of a system for enabling an airborne communication system when a natural disaster is detected according to an example embodiment;

FIG. 2B is a partial schematic view of a system for enabling an airborne communication system when a natural disaster is detected according to another example embodiment; and,

FIG. 3 is a non-limiting view of a deployed system according to an example embodiment.

### DETAILED DESCRIPTION OF EXAMPLE EMBODIMENTS OF THE INVENTION

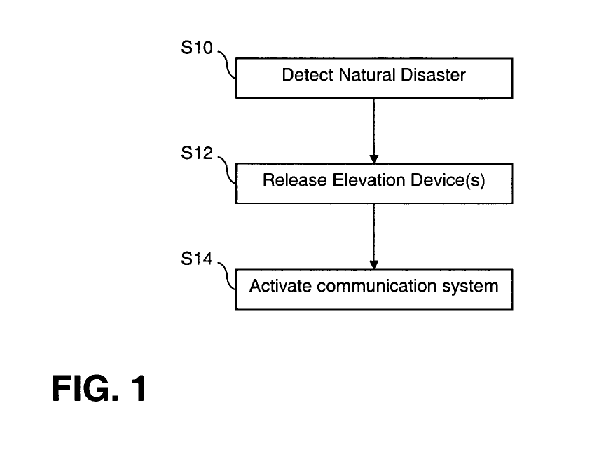

Referring now to the drawings, FIG. 1 is a flowchart according to a first exemplary embodiment. Step S10 detects whether a natural disaster is occurring or has occurred. The natural disasters detected in step S10 may include, for example, tropical depressions, earthquakes, hurricanes, tornados, tsunamis, wildfires, etc. Step S10 may monitor climatic attributes that typify the occurrence of natural disasters, such as, for example, sudden changes in barometric pressure, temperature increases above certain threshold levels, seismic activity, rising water levels, etc. It will be appreciated, however, that step S10 may detect other natural disasters apart from or in addition to the above non-limiting list, including those natural disasters that occur in alone, together, in succession, etc. It also will be appreciated that step S10 may monitor other indicators, alone or in combination, that are correlated with the existence of natural disasters.

Above-described step S10 employs an automatic detector that monitors climatic attributes correlated with the presence of natural disasters in order to, for example, keep people out of harm's way. However, other example embodiments are contemplated wherein step S10 might include a human element—e.g., the step of detecting a natural disaster may be undertaken by a human operator. A system with a human operator performing the detecting step may, for example, have the human operator located locally or remotely. In some example embodiments, having a human operator may be, for example, less expensive, more reliable, etc. than employing complex mechanical detectors.

If a natural disaster is detected in step S10, an elevation device will be released in step S12. In an example embodiment, a self-contained, independent communication component will be attached to the elevation device. In some example embodiments, in a step not shown in FIG. 1, the system may comprise the additional step of determining when to release the elevation device. The timing step may be used in view of the type of natural disaster occurring. For example, during an earthquake, it may make sense to release the elevation device as soon as seismic activity above a certain threshold is detected to avoid damage to the elevation device and accompanying communication component. However, releasing an elevation device during a tornado, for example, may prove counterproductive, as high winds may damage the elevation device itself and/or the communication component attached thereto. Alternatively, or in addition to the timing step, the release of the elevation device may require human confirmation in some example embodiments. In a preferred embodiment, the elevation device will consist of an inflatable balloon or plurality of inflatable balloons. For example, it is well known that weather balloons may remain aloft for long periods of time carrying sensitive equipment through a varied range of outside conditions. However, it will be appreciated that using a balloon or a plurality of balloons is only one elevation device, and other suitable elevation devices may be used in place of, or in combination with, the balloon or plurality of balloons.

Also, it will be appreciated that step S12 may release a plurality of elevation devices, each with an attached communication component. In some example embodiments, it may be necessary to release a plurality of elevation devices to cover a sufficiently broad area. In other example embodiments, it may be necessary to release a plurality of elevation devices to enable the specific communication system chosen. Details of the communication system will be discussed below in combination with step S14. Briefly, communication systems in accordance with some example embodiments may require multiple nodes for relaying communiques across a network of communications components. It will be appreciated that in implementing a network of nodes, the same communication components may be used on each elevation device, while in other example implementations, different communication components may be necessary. The former example implementation may constitute, in part, for example, an ad-hoc system of communication relays. The latter example implementation may constitute, in part, for example, a hub-and-spoke communication system.

Step S14 involves activating the communication system. The communication system can be one or more of, for example, a cellular system, satellite broadcast, short-wave radios, etc. The system may operate at various frequencies, depending on, for example, the communication system chosen, the specific needs of responders, the nature of the disaster, etc. For example, where law enforcement needs are especially great, the communication system may enable communication via police frequencies. Where, for example, the National Guard or the Army Corps of Engineers are deployed, the communication system may enable communication via military frequencies. In some example embodiments, the communication system may operate over open channels, while the communication may operate over secure and/or encrypted channels in other example embodiments. Similarly, depending on the example embodiment, the communication system may be restricted to certain users, certain groups of users, or open to all users.

In some example embodiments, before the system reaches the activating step, the system may wait for a human confirmation to activate the system. The additional step of requiring human confirmation may be advantageous in cases where, for example, natural disasters are detected which trigger the elevation step, but where the airborne system is not needed. This may occur when, for example, traditional communications devices are not damaged by the natural disaster.

In still other example embodiments, the activating step may further comprise a verification step, wherein the operability of the airborne communication system is checked. Additionally, the communication system may accept a shut-down signal when, for example, the emergency period is over, traditional communication channels are restored, relief efforts are completed, etc.

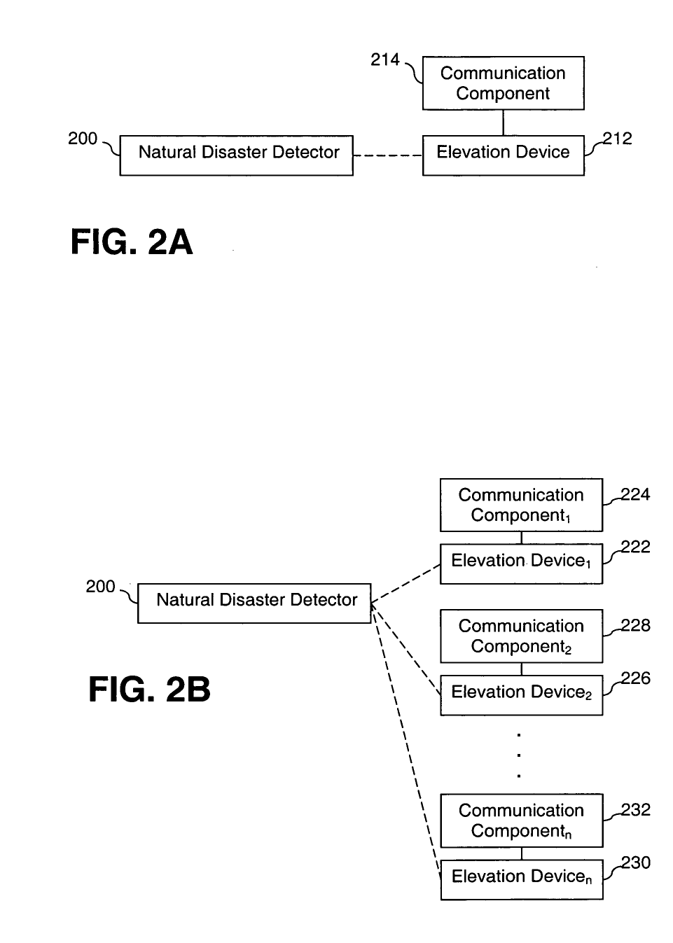

FIG. 2A is a partial schematic view of a system for enabling an airborne communication system when a natural disaster is detected according to an example embodiment. Natural disaster detector 200 determines the existence of one or more than one natural disaster. Natural disaster detector 200 may monitor climatic attributes, such as, for example, sudden changes in barometric pressure, temperature increases above certain threshold levels, seismic activity, rising water levels, etc. in order to indicate, for example, tropical depressions, earthquakes, hurricanes, tornados, tsunamis, wildfires, etc.

If a natural disaster is detected by natural disaster detector 200, elevation device 212 will rise, carrying communication component 214 with it. In a preferred embodiment, elevation device 212 will consist of one or more balloons. Communication component 214 may enable, for example, a cellular system, satellite broadcast, short-wave radios, etc., and it may operate at various frequencies—open or restricted—depending on, for example, the communication system chosen, the specific needs of responders, the nature of the disaster, etc.

FIG. 2B is a partial schematic view of a system for enabling an airborne communication system when a natural disaster is detected according to another example embodiment. In this example embodiment, when natural disaster detector 200 detects a natural disaster, one or more of a plurality of elevation devices, each carrying its own communication component, is/are released. For example, in a preferred embodiment that utilizes a multi-node system, it may be necessary to release a plurality of elevation devices to enable, for example, communication across a broad geographic area via cellular communications. In this example embodiment, different communication components may be necessary for different elevation devices, depending on the communication system implemented. For example, in some example embodiments, it may be necessary to have a central parent communication component in contact with child communication components.

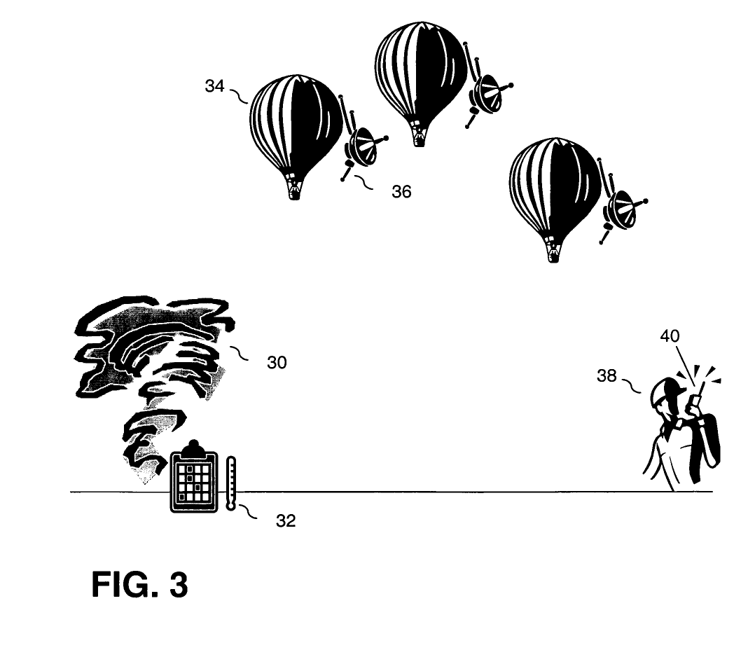

FIG. 3 is a non-limiting view of a deployed system according to an example embodiment. Considering FIG. 3 from left-to-right illustrates how an airborne communication system in accordance with one example embodiment may be deployed. Natural disaster 30, shown for non-limiting illustrative purposes as a tornado, is detected by natural disaster detector 32. When natural disaster 30 is detected, the plurality of elevation devices 34 rise, carrying the plurality of communication components 36 with them. After the airborne communication system is activated, rescue worker 38 is then able to use communication device 40, pictured for non-limiting illustrative purposes as a walkie-talkie.

In other example embodiments contemplated by the present invention, the plurality of elevation devices 34 pictured in FIG. 3 may be shielded and/or protected before they are deployed. Protecting and/or shielding the elevation devices may be necessary in some example embodiments to prevent the attached potentially-sensitive communication components from being damaged during the occurrence of the natural disaster. Such a shielding/protecting structure may have to be resilient enough to withstand, for example, high winds, falling debris, water damage.

It will be appreciated that while the example embodiments described may be used a replacement system for traditional, existing communication channels, the airborne communication system described herein may be used as an alternative system in place of, or in addition to, the existing communication channels. This may be necessary when, for example, traditional communication channels still function properly but become overloaded by an abnormally high-density call volume. Similarly, it will be appreciated that the airborne communication system may replace damaged nodes in an existing communication network. Thus, certain example embodiments may use the airborne communication system to “patch” holes in existing networks.

Additionally, it will be appreciated that multiple communication devices may be located on each elevation device in order to enable and/or make available a number of different communication networks. This function may be advantageous, for example, to create new communication channels for rescue workers while restoring traditional channels to everyday citizens.

Although the example embodiments herein have been described to detect natural disasters, it will be appreciated that airborne communication systems may be useful in other circumstances, including, for example, emergency situations in general. One obvious emergency situation that could have impacts similar to a natural disaster would be a terrorist attack.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of establishing an airborne communication system in view of a natural disaster, the method comprising:
detecting a natural disaster;
elevating a communication component in response to detecting the natural disaster; and
activating said communication component so that an airborne communication system is established.

2. The method of claim 1, wherein the natural disaster is a tropical depression, an earthquake, a hurricane, a tornado, a tsunami, a wildfire, and/or a terrorist attack.

3. The method of claim 1, wherein the detecting step monitors barometric pressure, temperature, seismic activity, and/or water levels.

4. The method of claim 1, further comprising requiring verification before elevating and/or activating the communication component.

5. The method of claim 1, wherein the activating step allows communication via telephones, cellular telephones, and/or walkie-talkies.

6. A method of establishing an airborne communication system in view of a disaster, the method comprising:
detecting a disaster or the possibility of a natural disaster;
in response to said detecting step, elevating a plurality of communication components; and,
activating said plurality of communication components.

7. The method of claim 6, wherein the elevating step elevates communication components to replace communication components damaged or which may be damaged by the disaster.

8. A system that establishes an airborne communication system, comprising:
a natural disaster detector;
an elevating device for elevating communications equipment in response to detection of a natural disaster; and,
a communication component attached to said elevating device so that an at least partially airborne communication system can be realized upon detection of the natural disaster.

9. The system of claim 8, wherein the natural disaster is a tropical depression, an earthquake, a hurricane, a tornado, a tsunami, a wildfire, and/or a terrorist attack.

10. The system of claim 8, wherein the natural disaster detector determines the presence of a natural disaster by monitoring barometric pressure, temperature, seismic activity, and/or water levels.

11. The system of claim 8, where a user confirms the output of the natural disaster detector and/or activates the communication component.

12. The system of claim 8, wherein the communication component allows communication via telephones, cellular telephones, and/or walkie-talkies.

13. The system of claim 12, wherein the communication component allows communication over a secure and/or restricted channel.

14. The system of claim 8, wherein the elevation device is a balloon.
